(19) United States
(12) Patent Application Publication
(10) Pub. No.: US 2003/0061053 A1
(43) Pub. Date: Mar. 27, 2003

(54) Method and apparatus for processing inputs into a computing device

(76) Inventors: Michael J. Payne, Beaverton, OR (US); Rohan Coelho, Portland, OR (US); Maher M. Hawash, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/964,951

(22) Filed: Sep. 27, 2001

(51) Int. Cl. G10L 21/00

(52) U.S. Cl. 704/270

(57) ABSTRACT

In an embodiment, a method includes associating each of a quantity of numbers of a speech-enabled numbered list with an entry of a quantity of entries. The method also includes receiving, through a voice input, a selection of a number of the quantity of numbers. Additionally, the method includes obtaining data for the entry of the quantity of entries that is associated with the number.

### FIELD OF THE INVENTION

The invention relates to the field of processing of inputs into a computing device. More specifically, the invention relates to processing of different inputs, including voice recognition, received into a computing device.

### BACKGROUND OF THE INVENTION

Various input devices and methods exist today to interface with computing devices. Common input types include a keyboard and mouse. Users have full control of what is inputted into the devices when they use a keyboard and a mouse; a mouse click and a keystroke are tied directly to predetermined system interpretations, and thus the computing device has high confidence that when these methods of input are used the input will be accurately interpreted.

A method to interface with a computing device by touching the screen was developed to be used in some applications of computing devices such as entering food orders in the restaurant business or writing your schedule on a PALM device. This type of interface is generally performed by touching the screen with a stylus or with a person's finger. Users have fall control of what they touch on the screen, which corresponds to what is inputted into the computing device, so a stylus interface is an accurate and efficient user interface for some applications of computing devices. The computing device has high confidence that the input the user selected is correct.

Speech-enabled interface is the next logical advancement in user interface to a computing device; however, the technology has not been perfected because of the difficulty that computing devices have in interpreting speech accurately. Voice recognition applications allow computing devices to interpret speech and understand the operation the user wants. Computing devices with voice recognition applications have a vocabulary of words that the device understand as a speech input and will perform a task or retrieve some data as a result of the speech input. Computing devices usually have to match a speech input to a large vocabulary list to perform the required operation. Since the available entries are numerous when there is a large vocabulary, the computing device has more difficulty accurately detecting and interpreting what the user voiced. Sometimes the speech input is too lengthy for the computing device to interpret correctly. Multiple matches or errors are common because of phonically similar items in the vocabulary list; therefore, voice recognition applications can be inaccurate and inefficient so such inputs are not widely used as a user interface method.

### BRIEF DESCRIPTION OF THE DRAWINGS

Embodiments of the invention may be best understood by referring to the following description and accompanying drawings that illustrate such embodiments. The numbering scheme for the Figures included herein are such that the leading number for a given element in a Figure is associated with the number of the Figure. For example, system 100 can be located in FIG. 1. However, element numbers are the same for those elements that are the same across different Figures.

In the drawings:

FIG. 1 illustrates an exemplary computer system that includes a machine-readable medium on which is stored a set of instructions, according to embodiments of the present invention.

FIG. 2 illustrates a flow diagram of the method relating to speech-enabled numbered lists, according to embodiments of the present invention.

FIG. 3 illustrates a screen shot that includes a speech-enabled numbered list, according to embodiments of the present invention.

FIG. 4 illustrates another screen shot that includes a speech-enabled numbered list, according to embodiments of the present invention.

FIG. 5 illustrates a flow diagram for making decisions based on confidence distinction of the input type, according to embodiments of the present invention.

FIG. 6 illustrates a screen shot of a verification list with a speech-enabled numbered list, according to embodiments of the present invention.

FIG. 7 illustrates a flow diagram for making decisions based on confidence distinction of various input types (including speech-enabled numbered lists), according to embodiments of the present invention.

### DETAILED DESCRIPTION

In the following description, numerous specific details are set forth to provide a thorough understanding of the invention. However, it is understood that the invention may be practiced without these specific details. In other instances, well-known structures and techniques have not been shown in detail in order not to obscure the invention.

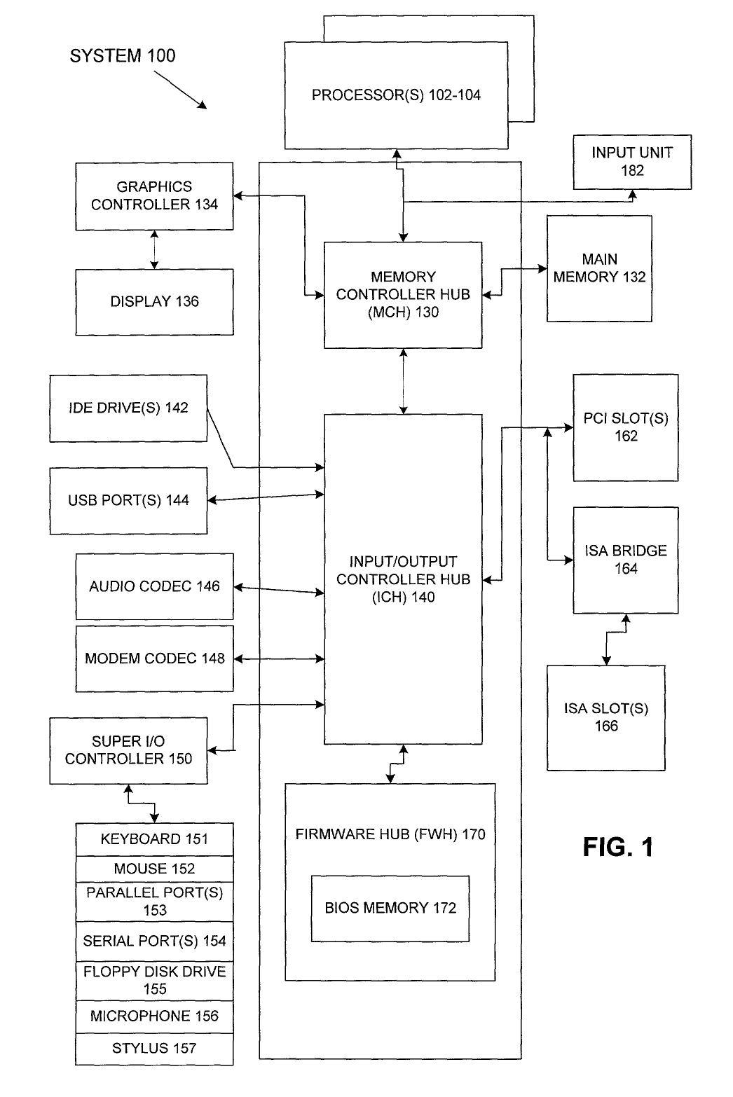

FIG. 1 illustrates an exemplary system 100 comprising processors 102 and 104 for processing of speech enabled input, according to embodiments of the present invention. Although described in the context of system 100, embodiments of the present invention may be implemented in any suitable computer system comprising any suitable one or more integrated circuits.

As illustrated in FIG. 1, computer system 100 comprises processor 102 and processor 104. Computer system 100 also includes processor bus 110, and chipset 120. Processors 102 and 104 and chipset 120 are coupled to processor bus 110. Processors 102 and 104 may each comprise any suitable processor architecture and for one embodiment comprise an Intel® Architecture used, for example, in the Pentium® family of processors available from Intel® Corporation of Santa Clara, Calif. Computer system 100 for other embodiments may comprise one, three, or more processors any of which may execute a set of instructions that are in accordance with embodiments of the present invention.

Chipset 120 for one embodiment comprises memory controller hub (MCH) 130, input/output (I/O) controller hub (ICH) 140, and firmware hub (FWH) 170. MCH 130, ICH 140, and FWH 170 may each comprise any suitable circuitry and for one embodiment is each formed as a separate integrated circuit chip. Chipset 120 for other embodiments may comprise any suitable one or more integrated circuit devices.

MCH 130 may comprise any suitable interface controllers to provide for any suitable communication link to processor bus 110 and/or to any suitable device or component in communication with MCH 130. MCH 130 for one embodiment provides suitable arbitration, buffering, and coherency management for each interface.

MCH 130 is coupled to processor bus 110 and provides an interface to processors 102 and 104 over processor bus 110. Processor 102 and/or processor 104 may alternatively be combined with MCH 130 to form a single chip. MCH 130 for one embodiment also provides an interface to a main memory 132 and a graphics controller 134 each coupled to MCH 130. Main memory 132 stores data and/or instructions, for example, for computer system 100 and may comprise any suitable memory, such as a dynamic random access memory (DRAM) for example. Graphics controller 134 controls the display of information on a suitable display 136, such as a cathode ray tube (CRT) or liquid crystal display (LCD) for example, coupled to graphics controller 134. MCH 130 for one embodiment interfaces with graphics controller 134 through an accelerated graphics port (AGP). Graphics controller 134 for one embodiment may alternatively be combined with MCH 130 to form a single chip.

MCH 130 is also coupled to ICH 140 to provide access to ICH 140 through a hub interface. ICH 140 provides an interface to I/O devices or peripheral components for computer system 100. ICH 140 may comprise any suitable interface controllers to provide for any suitable communication link to MCH 130 and/or to any suitable device or component in communication with ICH 140. ICH 140 for one embodiment provides suitable arbitration and buffering for each interface.

For one embodiment, ICH 140 provides an interface to one or more suitable integrated drive electronics (IDE) drives 142, such as a hard disk drive (HDD) or compact disc read only memory (CD ROM) drive for example, to store data and/or instructions for example, one or more suitable universal serial bus (USB) devices through one or more USB ports 144, an audio coder/decoder (codec) 146, and a modem codec 148. ICH 140 for one embodiment also provides an interface through a super I/O controller 150 to a keyboard 151, a mouse 152, a microphone 156, a stylus 157, one or more suitable devices, such as a printer for example, through one or more parallel ports 153, one or more suitable devices through one or more serial ports 154, and a floppy disk drive 155. ICH 140 for one embodiment further provides an interface to one or more suitable peripheral component interconnect (PCI) devices coupled to ICH 140 through one or more PCI slots 162 on a PCI bus and an interface to one or more suitable industry standard architecture (ISA) devices coupled to ICH 140 by the PCI bus through an ISA bridge 164. ISA bridge 164 interfaces with one or more ISA devices through one or more ISA slots 166 on an ISA bus.

ICH 140 is also coupled to FWH 170 to provide an interface to FWH 170. FWH 170 may comprise any suitable interface controller to provide for any suitable communication link to ICH 140. FWH 170 for one embodiment may share at least a portion of the interface between ICH 140 and super I/O controller 150. FWH 170 comprises a basic input/output system (BIOS) memory 172 to store suitable system and/or video BIOS software. BIOS memory 172 may comprise any suitable non-volatile memory, such as a flash memory for example.

Additionally, computer system 100 includes input unit 180. In an embodiment, input unit 180 can be a process or task that can reside within main memory 132 and/or processors 102 and 104 and can be executed within processors 102 and 104. However, embodiments of the present invention are not so limited, as input unit 180 can be different types of hardware (such as digital logic) executing the processing described therein (which is described in more detail below).

Accordingly, computer system 100 can include a machine-readable medium on which is stored a set of instructions (i.e., software) embodying any one, or all, of the methodologies described herein. For example, software can reside, completely or at least partially, within main memory 132 and/or within processors 102-104. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

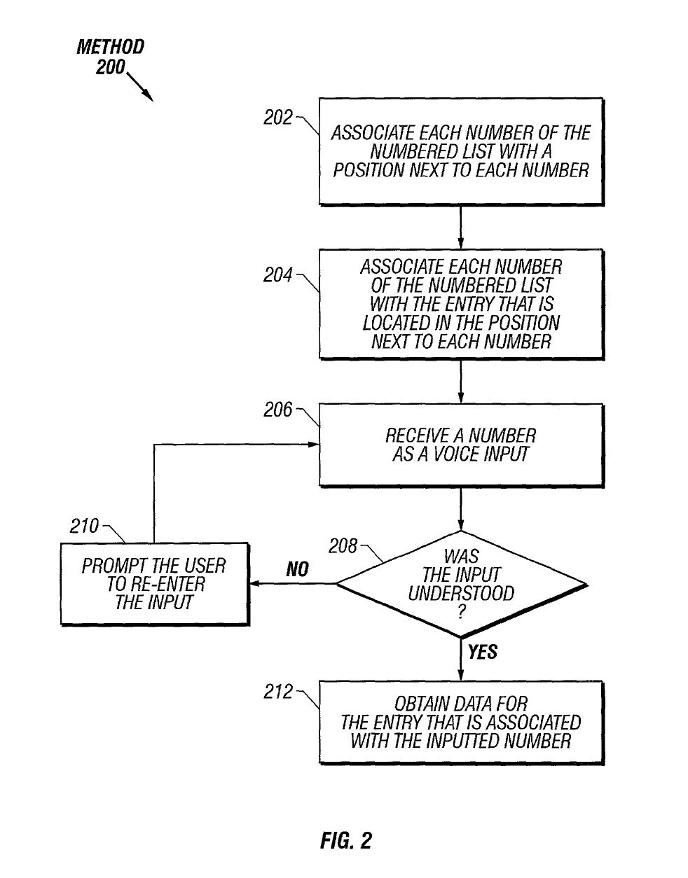

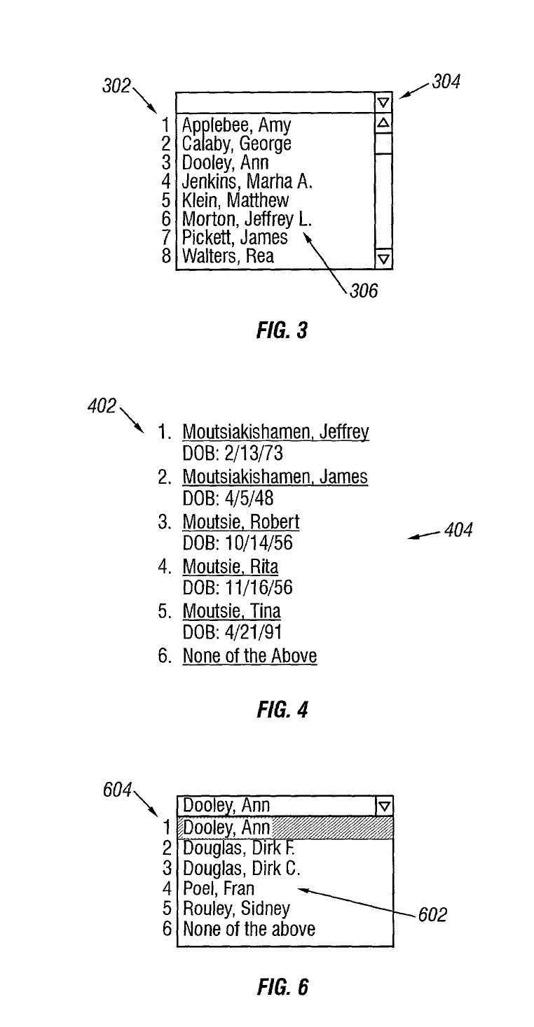

The operations of input unit 180 will now be described in conjunction with the flow diagram of FIG. 2. In particular, FIG. 2 illustrates a flow diagram of the method 200 relating to speech-enabled numbered lists, according to embodiments of the present invention. To help illustrate FIG. 2, FIG. 3 and FIG. 4 illustrate screen shots that include speech-enabled numbered lists, according to embodiments of the present invention. In particular, FIG. 3 illustrates a screen shot that includes speech-enabled numbered list 302 next to combo box 304 containing list of entries 306. There are different embodiments of speech-enabled numbered lists, which may be made up of any list of entries within any type of viewable list so it is not limited to a list of personal names within a combo box. For example, a speech-enabled numbered list can be used next to any type of viewable list such as a drop-down box or a scroll list box, and the viewable list can contain any list of entries such as product brands, company stock symbols, or names of prescription drugs. Thus, a viewable list is defined as any type of list that allows the user to view the entries. Speech-enabled numbered lists are user interface features that afford a means to use speech recognition, according to embodiments of the present invention. Such lists allow users to select the desired entry by voicing the number, from the speech-enabled numbered list, that is associated with the entry in the position next to the number at that time. For example, in FIG. 3 Ann Dooley can be selected by saying “three” instead of saying “Ann Dooley.”

The numbers in the speech-enabled numbered list 302 are fixed in position, not fixed to an entry in the list 306. For example, in FIG. 3 the number 2 currently corresponds to “Calaby, George”; however, if the user scrolls down the list 306, the entries move but the number 2 does not move. The number 2 becomes associated with whatever name from the list 306 is in the position next to the number 2 at any time. Accordingly, if the user moved down the list 306 by one entry, the number 2 will now be associated with “Dooley, Ann.” Thus, the user is able to limit the number of items in the vocabulary list that input unit 180 must recognize to a specific range—the quantity of numbers of the speech-enabled numbered list. Accordingly, the vocabulary list of numbers recognized through speech recognition is limited to the quantity of numbers of the speech-enabled numbered list, which increases the probability of accurately recognizing the voice entry. However, the limited vocabulary list of numbers that helps accuracy does not limit the power and versatility of voice recognition using speech-enabled numbered lists because the numbered lists can contain unlimited number of entries. For example, a speech-enabled numbered list where the quantity of numbers in the speech-enabled numbered list is ten (the size of the numbered list is 10) can have fifty entries, five thousand entries, five hundred thousand entries, or more. Once input unit 180 recognizes the number that was voiced by the user, the unit knows what entry the user desired to select.

When lists contain items that are phonetically similar, accurate voice recognition becomes difficult if the user must say a voice keyword, such as the name of the item itself; input unit 180 can easily recognize the speech input when a number is being said because numbers are more phonetically dissimilar than voice keywords. Voicing a number from speech-enabled numbered list 302 increases the likelihood of input unit 180 accurately recognizing the voice input and accurately identifying the user's desired selection.

To further help illustrate FIG. 2, FIG. 4 illustrates another screen shot that includes a speech-enabled numbered list, according to embodiments of the present invention. In this embodiment, speech-enabled numbered list 402 is next to list of entries 404. Each number of the quantity of numbers of speech-enabled numbered list 402 is fixed to an entry of the list of entries 404 that is in the position next to the number. In this type of list, each number of the quantity of numbers is fixed in position as well as fixed to an entry of the list of entries. For example, the number 4 will be fixed to “Rita Moutsie” which is located in the position next to the number 4.

Items in a list are often phonetically similar so accurate voice recognition is extremely difficult. For example, in FIG. 4 the name “Rita Moutsie” in the position next to number 4 and the name “Tina Moutsie” in the position next to number 5 are phonetically similar. By using the speech-enabled numbered list 402, the user can say a number rather than the name itself to select the entry. Input unit 180 is able to attribute distinctly different phonetics with any listed item and greatly increase the likelihood of accurate recognition.

Speech-enabled numbered lists give the user a concise speech entry, rather than the sometimes lengthy entries that would otherwise be required if the user was saying a voice keyword. For example, in FIG. 4, input unit 180 would have a hard time distinguishing “Jeffrey Moutsiakishamen” and “James Moutsiakishamen” if the names were voiced because both names are lengthy and both are phonetically similar. Accordingly, embodiments of the present invention allow a user to voice a number from the speech-enabled numbered list 402, which corresponds at that time to the desired name.

Returning to method 200 in FIG. 2, and focusing on the speech-enabled numbered list in FIG. 3 as an example, input unit 180 associates a number from speech-enabled numbered list 302 with a position next to the number, at process block 202. By associating a number to a position next to the number, input unit 180 consequently associates the number to the entry from list of entries 306 that is in the position next to the number at any time, at process block 204. For example, in FIG. 3 the number 2 currently corresponds to “Calaby, George”; however, if the user scrolls down list of entries 306, the entries move but the number 2 does not move. The number 2 becomes associated with whatever name from list of entries 306 is in the position next to the number 2 at any time. Accordingly, if the user moved down list of entries 306 by one entry, the number 2 will now be associated with “Dooley, Ann.”

The user then selects a particular entry from the list when the entry is positioned in the visible area of the screen. If the entry is not visible, the user finds and places the desired entry within the visible area of the screen to be able to voice a number that is associated to the entry. The user can position the desired entry in the visible area of the screen by various methods including, but not limited to, scrolling down the list. Thus, input unit 180 receives an input from the user that instructs the modification of the position of the list of entries so the desired entry is in the visible area of the screen. When the entry is visible, input unit 180 receives a number from the user through microphone 156 (of FIG. 1) by a voice input, at process block 206. Input unit 180 checks if it can determine or understand the input, at process decision block 208. If the input was not determined, input unit 180 prompts the user to re-enter the input, at process block 210. If the input is determined, input unit 180 obtains the data for the entry that is associated with the inputted number, at process block 212.

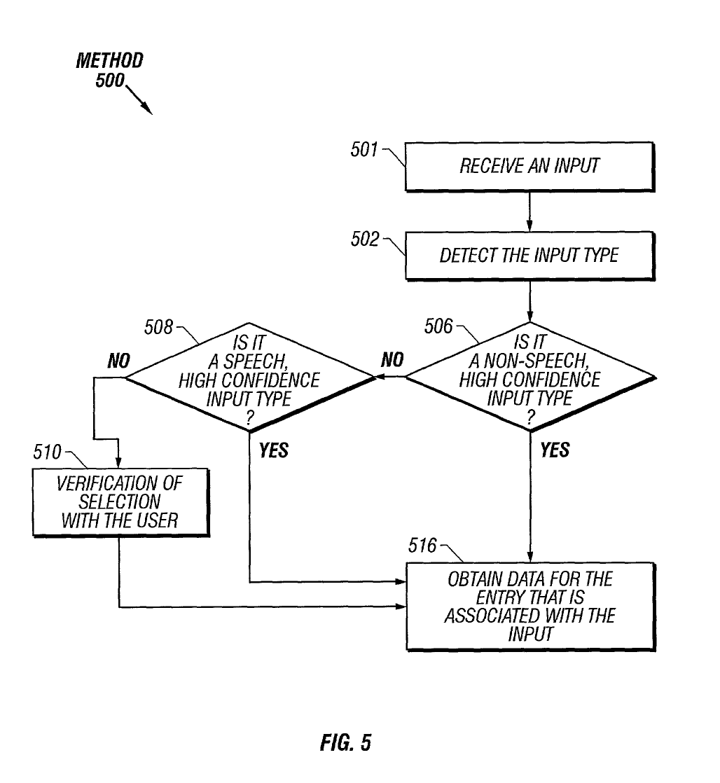

FIG. 5 illustrates a flow diagram for making decisions based on confidence distinction of the input type, according to embodiments of the present invention. Computing devices are interfaced with different input methodologies with varying degrees of confidence. Accordingly, these computing devices will be more confident that they interpreted the input accurately when the user utilizes high confidence input methods rather than moderate confidence input methods.

Method 500 of FIG. 5 commences with the receipt of an input by input unit 180 through input/output controller hub (ICH) 140, at process block 501. After receipt of input, input unit 180 detects the type of input, at process block 502. Input unit 180 assigns a level of confidence based on the input type detected. In one embodiment, input types can be grouped into two broad categories of input types: non-speech input and speech input. Input unit 180 assigns high confidence to non-speech input types such as keyboards and assigns high confidence to speech input types using speech-enabled numbered lists, which are described above in conjunction with FIGS. 2-4. Input unit 180 assigns moderate confidence to speech input types that do not use speech-enabled numbered lists. Non-speech input types such as inputs from keyboard 151, mouse 152, and stylus 157 have high confidence ratings because a mouse click, a tap of a screen, and a keystroke are all tied directly to predetermined system interpretations, and thus input unit 180 has high confidence that when these types of input are used the input will be accurately interpreted. Speech-enabled numbered lists allow the user to use speech as the input type knowing that input unit 180 has high confidence that the correct item is selected as described above in conjunction with FIGS. 2-4. Voicing a number gives the user high confidence that the input will be recognized correctly because there is a limited vocabulary list of numbers for input unit 180 to have to interpret accurately, and even though there is substantial overlap in phonetics that can cause problems in voice recognition, the speech-enabled numbered list can help reduce this problem because numbers are phonetically different. However, embodiments of the present invention are not limited to the segregation of the input types into two categories. For example, in an embodiment, the categories could include (1) non-speech, (2) speech-enabled numbered lists and (3) other speech inputs.

Based on the confidence level of the input type, input unit 180 determines whether to verify the input. Therefore, the response by input unit 180 to the input is different depending on the type of input as illustrated in FIG. 5. Input unit 180 determines whether the input type is a non-speech, high confidence input type, at process decision block 506. If input is a non-speech, high confidence input type, input unit 180 obtains the data for the entry that is associated with the input independent of performing verification of the input, at process block 516. Additionally, if the input type is not a non-speech, high confidence input type, input unit 180 determines if the input is a speech, high confidence input type using speech-enabled numbered lists, at process decision block 508. Upon determining that the input is a speech, high confidence input type using speech-enabled numbered lists, input unit 180 obtains the data associated with the input independent of performing verification of the input, at process block 516. For example, in FIG. 2, if the user voices the number 3, “Dooley, Ann” is accepted as the input and input unit 180 obtains the data associated with “Dooley, Ann” independent of performing verification of the input because the input type is assigned high confidence.

Upon determining the input type is a speech, moderate confidence input type without speech-enabled numbered lists, input unit 180 performs verification of the input, at process block 510. With speech-enabled input types that do not use speech-enabled numbered lists but rather accept voice keywords as speech inputs, input unit 180 must phonetically compare and match a speech input to a vocabulary list of all available voice keywords. If the vocabulary list is large or the items in the vocabulary list are phonetically similar to one another, confidence in accurate detection of the speech input is lowered in comparison to a non-speech input type or a speech entry using a speech-enabled numbered list.

Because speech interface methods without speech-enabled numbered lists have moderate confidence ratings, input unit 180 verifies the selection with the user, at process block 510. For example, in FIG. 2, if the user says the voice keyword “Ann Dooley” input unit 180 phonetically compares and matches “Ann Dooley,” to a vocabulary list of available voice keywords. After input unit 180 finds the vocabulary items that match “Ann Dooley,” input unit 180 asks the user to verify the input by examining the list of matching vocabulary items.

To help illustrate, FIG. 6 shows a screen shot of a verification list with a speech-enabled numbered list, according to embodiments of the present invention. Verification list 602 with a speech-enabled numbered list 604 would appear after saying the voice keyword “Ann Dooley.” Input unit 180 has selected the vocabulary item that matches the speech input. The user determines whether the selected item is the desired item. If the selected item is correct, the user confirms the selection by once again selecting the item but this time with a high confidence input method including, but not limited to, saying the number 1 or clicking with a mouse. Additionally, the user can confirm the selection by clicking on a “next” button (a continue option) that appears at the bottom of the screen (not shown in FIG. 6). Input unit 180 can obtain the data for the entry that is associated with the input, at process block 516. If the selected entry is incorrect, the user checks to see if the correct entry is displayed in the list showing all the matching entries. If the desired entry is in the list, the user selects the correct entry using a high confidence input method. Input unit 180 can obtain the data for the entry that is associated with the input, at process block 516. If the desired entry is not in the list of matching results, the user selects “none of the above” and then the user is prompted to re-enter an input. Embodiments of the present invention are not limited to the verification of the input illustrated by FIG. 6. For example, in another embodiment, input unit 180 could present the user with a single entry, thereby allowing the user to verify this selection or re-enter the input.

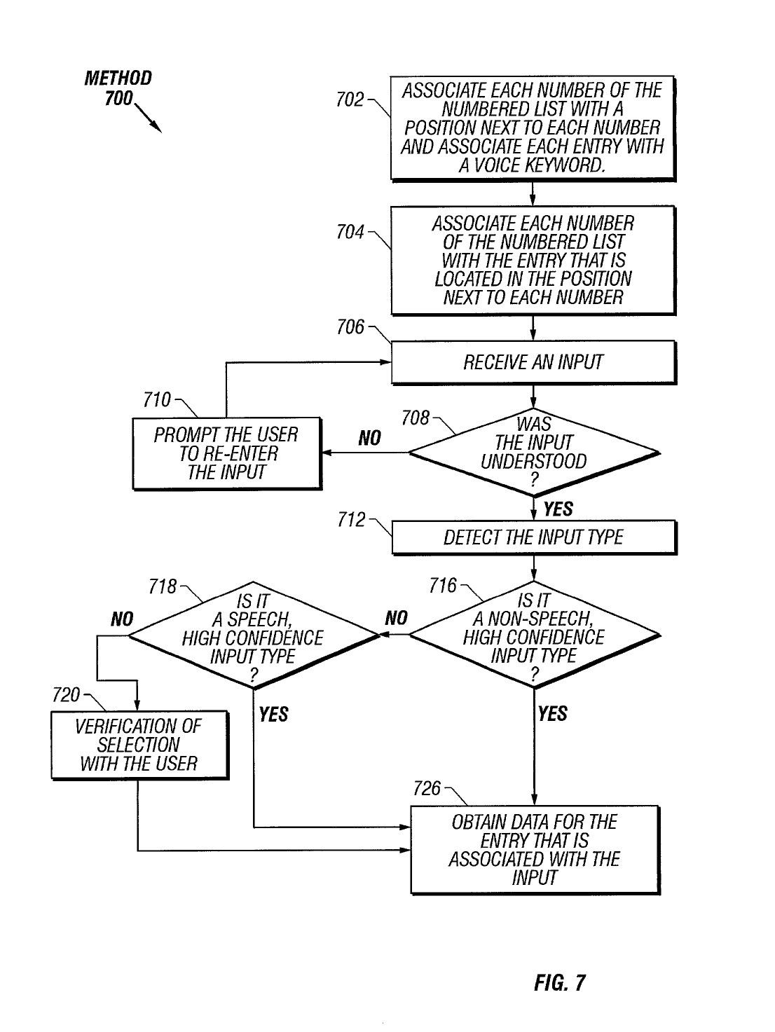

FIG. 7 illustrates a flow diagram for making decisions based on confidence distinction of various input types (including speech-enabled numbered lists), according to embodiments of the present invention. Method 700 commences with input unit 180 associating a number of the speech-enabled numbered list with a position in the viewable list next to the number and associates each entry with a voice keyword, at process block 702. For example, in FIG. 3, the number 2 in speech-enabled numbered list 302 is associated to the position next to the number. The entry “Calaby, George” in FIG. 3 is associated, for example, to the voice keyword “George Calaby.” Additionally, input unit 180 associates each of the numbers of the speech-enabled numbered list with an entry that is located in the position next to each of the numbers at any time, at process block 704. For example, in FIG. 3, the number 2 currently corresponds to “Calaby, George”; however, if the user scrolls down the list 306, the entries move but the number 2 does not move. The number 2 becomes associated with whatever name from the list 306 is in the position next to the number 2 at that particular time. Accordingly, if the user moved down the list 306 by one entry, the number 2 will now be associated with “Dooley, Ann.”

Input unit 180 receives an input from the user, at process block 706. The user can use any input type to select the desired entry; if the user chooses to say the voice keyword associated with the entry, then the entry does not have to be visible in the screen since input unit 180 conducts a search to find the entries that match the voice keyword. The matching entries will then be displayed for the user to verify if the selected entry that input unit 180 determined matched the voice keyword was the desired entry, as described above under FIG. 6. If the user chooses to select an entry with a mouse, stylus, or other non-speech input types or with a speech-enabled numbered list, the desired entry is in the visible area of the screen for the user to click on the entry, tap the screen, or say the number associated with the entry at that time. If the entry is not visible, the user can find and place the desired selection in the visible area of the screen to be able to select the entry. The user can position the desired entry in the visible area of the screen by various methods including, but not limited to, scrolling down the list. Thus, input unit 180 receives an input from the user that instructs the modification of the position of the list of entries so the desired entry is in the visible area of the screen.

Input unit 180 checks whether the input can be determined or understood, at process decision block 708. If the input was not determined, input unit 180 prompts the user to re-enter the input, at process block 710. Conversely, if the input is determined, input unit 180 detects the input type, at process block 712. Additionally, input unit 180 assigns a level of confidence with that specific type of input. Based on the confidence level of the input type, input unit 180 determines whether to perform verification of the input. Therefore, the response by input unit 180 to the input is different depending on the type of input as illustrated in FIG. 7. Input unit 180 determines whether the input type is a non-speech, high confidence input type, at process decision block 716. If the input is a non-speech, high confidence input type, input unit 180 obtains the data for the entry that is associated with the input independent of performing verification of the input, at process block 726. If the input type is not a non-speech, high confidence input type, input unit 180 determines if the input is a speech input type using speech-enabled numbered lists, at process decision block 718. If the input is a speech, high confidence input type using speech-enabled numbered lists, input unit 180 obtains the data associated with the input independent of performing verification of the input, at process block 726.

If input unit 180 determines the input type is a speech, moderate confidence input type without speech-enabled numbered lists, verification of the input is performed, at process block 720. After input unit 180 finds the vocabulary items that match the speech input, input unit 180 asks the user to verify the input by examining the list of matching vocabulary items. Input unit 180 has selected the vocabulary item that best matches the speech input. The user then determines whether the selected item is the desired item. If the selected item is correct, the user confirms the selection by once again selecting the item but this time with a high confidence input method, such as saying the number in the position next to the selected item or by clicking it with a mouse. Now the input unit 180 can obtain the data for the entry that is associated with the input, at process block 726. If the selected entry is incorrect, the user checks to see if the correct entry is displayed in the list showing all the matching entries. If the desired entry is in the list, the user selects the correct entry using a high confidence input method. Then, input unit 180 can obtain the data for the entry that is associated with the input, at process block 726. If the desired entry is not in the list of matching results, the user selects “none of the above” and then the user is prompted to re-enter an input.

In domains where a mistake in accuracy can lead to critical negative outcomes (e.g., prescribing medication to the wrong patient or prescribing the wrong medicine to a patient), the input needs to be recognized correctly. If confidence-based methods are employed (as described herein), critical inputs are recognized accurately by requiring user verification for inputs received via moderate confidence input types. By using confidence-based methods, users can also ensure that the user is not annoyingly asked to verify a selection when the user utilized a high confidence input type.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
associating each of a quantity of numbers of a speech-enabled numbered list with an entry of a quantity of entries;
receiving, through a voice input, a selection of a number of the quantity of numbers; and
obtaining data for the entry of the quantity of entries that is associated with the number.

2. The method of claim 1, wherein each of the quantity of numbers of the speech-enabled numbered list is fixed to a position next to each of the quantity of numbers independent of the entry located at the position next to each of the quantity of numbers.

3. The method of claim 1, further comprising receiving a new selection of the number of the quantity of numbers if the voice input could not be determined.

4. The method of claim 1, wherein the quantity of entries is greater than the quantity of numbers.

5. The method of claim 1, further comprising receiving an input that modifies positions of the quantity of entries.

6. A method comprising:
associating each of a quantity of numbers of a speech-enabled numbered list with a position in a viewable list; associating each of the quantity of numbers of the speech-enabled numbered list with an entry of a quantity of entries that is located in the position in the viewable list;
receiving an input, wherein the input can be one of a number of input types, each of the number of input types associated with a number of different levels of confidence; and
obtaining data for the entry of the quantity of entries that is associated with the input.

7. The method of claim 6, further comprising verifying the input upon determining that the input type of the input is associated with a moderate level of confidence.

8. The method of claim 7, wherein the verifying of the input includes generating a list of matching items from a vocabulary list.

9. The method of claim 7, wherein the input type associated with the moderate level of confidence includes a voice input that is independent of the speech-enabled numbered list.

10. The method of claim 6, further comprising associating each of the quantity of entries with a voice keyword.

11. The method of claim 6, wherein each of the quantity of numbers of the speech-enabled numbered list is fixed to the position next to each of the quantity of numbers independent of the entry located at the position next to each of the quantity of numbers.

12. The method of claim 6, further comprising receiving an input that modifies positions of the quantity of entries.

13. The method of claim 6, wherein the quantity of entries is greater than the quantity of numbers.

14. The method of claim 6, further comprising receiving an additional input if the input could not be determined.

15. A system comprising:
an input device coupled to receive, through a voice input, a selection of a number of a quantity of numbers of a speech-enabled numbered list; and
an input unit coupled with the input device, the input unit to associate each of the quantity of numbers of the speech-enabled numbered list with an entry of a quantity of entries, wherein the input unit is to obtain data for the entry of the quantity of entries that is associated with the number based on the selection of the number through the voice input.

16. The system of claim 15, wherein the input unit is to receive a new selection of the number of the quantity of numbers if the voice input could not be determined.

17. The system of claim 15, wherein the input unit is to receive an input that modifies positions of the quantity of entries.

18. A system comprising:
a number of input devices coupled to receive a number of inputs, wherein each of the number of inputs can be one of a number of input types, each of the number of input types associated with a number of different levels of confidence; and
an input unit coupled to the number of input devices, the input unit to associate each of a quantity of numbers of a speech-enabled numbered list with an entry of a quantity of entries that is located in a position in a viewable list, wherein the input unit is to obtain data for the entry of the quantity of entries that is associated with the input based on the selection of the entry through the input.

19. The system of claim 18, wherein the input unit is to verify the input upon determining that the input type of the input is associated with a moderate level of confidence.

20. The system of claim 19, wherein the input unit is to generate a list of matching items from a vocabulary list to verify the input.

21. The system of claim 20, wherein the input unit is to associate each of the quantity of entries with a voice keyword.

22. A machine-readable medium that provides instructions, which when executed by a machine, causes the machine to perform operations comprising:
associating each of a quantity of numbers of a speech-enabled numbered list with an entry of a quantity of entries;
receiving, through a voice input, a selection of a number of the quantity of numbers; and
obtaining data for the entry of the quantity of entries that is associated with the number.

23. The machine-readable medium of claim 22, wherein each of the quantity of numbers of the speech-enabled numbered list is fixed to a position next to each of the quantity of numbers independent of the entry located at the position next to each of the quantity of numbers.

24. The machine-readable medium of claim 22, wherein the quantity of entries is greater than the quantity of numbers.

25. The machine-readable medium of claim 22, further comprising receiving an input that modifies positions of the quantity of entries.

26. A machine-readable medium that provides instructions, which when executed by a machine, causes the machine to perform operations comprising:
associating each of a quantity of numbers of a speech-enabled numbered list with a position in a viewable list;
associating each of the quantity of numbers of the speech-enabled numbered list with an entry of a quantity of entries that is located in the position in the viewable list;
receiving an input, wherein the input can be one of a number of input types, each of the number of input types associated with a number of different levels of confidence; and
obtaining data for the entry of the quantity of entries that is associated with the input.

27. The machine-readable medium of claim 26, further comprising verifying the input upon determining that the input type of the input is associated with a moderate level of confidence.

28. The machine-readable medium of claim 27, wherein the verifying of the input includes generating a list of matching items from a vocabulary list.

29. The machine-readable medium of claim 26, further comprising associating each of the quantity of entries with a voice keyword.

30. The machine-readable medium of claim 26, wherein each of the quantity of numbers of the speech-enabled numbered list is fixed to the position next to each of the quantity of numbers independent of the entry located at the position next to each of the quantity of numbers.
